(19) United States
(12) Patent Application Publication
(10) Pub. No.: US 2018/0118442 A1
(43) Pub. Date: May 3, 2018

(54) VACUUM INSULATED CANISTER AND BOWL

(71) Applicants: BRIAN SHAWN BAUGH, POOLER, GA (US); BILLY R BAUGH, POOLER, GA (US)

(72) Inventors: BRIAN SHAWN BAUGH, POOLER, GA (US); BILLY R BAUGH, POOLER, GA (US)

(21) Appl. No.: 15/340,988

(22) Filed: Nov. 2, 2016

(51) Int. Cl. B65D 81/38; B65D 55/16; B65D 43/02; B65D 41/04; B65D 51/18; A01K 7/02

(52) U.S. Cl. CPC B65D 81/3818; B65D 55/16; B65D 43/02; B65D 41/04; B65D 2251/009; A01K 7/02; B65D 2251/0015; B65D 2251/0028; B65D 2251/0081; B65D 51/18

(57) ABSTRACT

The present invention of a vacuum insulated canister and bowl for animals enabled to retain the provided liquid temperature for long time and therefore enabled to provide a good source of hot/cold water to the pet/animals when and wherever required. The vacuum insulated double walled construction is made up of stainless steel. The vacuum insulated liquid dispenser has an added grip. The container provided herein for storing the dispensed water from the liquid dispenser is also double walled and is vacuum insulated. The vacuum insulated liquid dispenser also enables ice water to retain its temperature for longer periods of time. The container provided herein refills water automatically from an attached insulated canister when assembled.

### FIELD OF INVENTION

The present invention relates to providing a portable, self dispensing source of cold water for long periods of time to animals.

### BACKGROUND OF THE INVENTION

A balanced diet is not the only necessary part of keeping your pets healthy. Water for drinking is also a very important part of your pet's daily requirements and overall nutrition. Water is the main component of healthy, living cells of the body. Without water, your pet's body will not be able to function properly. More specifically, your pet will dehydrate. In order for your pet to get enough water daily, you need to provide water along with a healthy, balanced diet (which also provides some moisture).

Having clean drinking water available to your pets is of primary importance for their wellbeing. However, the traditional water bowl requires refilling frequently and does not retain temperature for long because the contents of the bowl and its surfaces are largely exposed to the air where convection occurs.

Moreover, if an animal is overheated or is in a hot environment, having access to cold water helps the animal to maintain a healthy body temperature. As many animals primarily rid their body of excess heat through the mouth, drinking cold water can be very effective in controlling body temperature.

Therefore, there remains a need to overcome above mentioned problems and our invention resolve these entire problems.

### SUMMARY OF THE INVENTION

The present invention relates to a vacuum insulated liquid canister with bowl attachment for pets and animals enabled to retain the provided liquid and ice at temperature for long periods of time and therefore provides an efficient, portable, source of cold water to animals when and wherever required.

The invention consists of a first unit and a second unit. The first unit comprising a double walled insulated canister with a first lid and a second lid. The first lid of the first unit enables the canister to be closed completely and to be magnetized to the body of the canister when unfastened. The first lid is further attached to the second lid by a tether. The second lid of the first unit have a threaded male coupling which is to be received by the receiving couple of the second unit and a large threaded female coupling which enables the second lid to be coupled to the main body of the first unit. The second lid of the first unit and the main body of the first unit are further encased either partially or completely on the outer surfaces with a grip material to provide a gripping surface to at least one user. The second unit comprises a double walled vacuum insulated threaded female receiving couple with a conduit to a broad opening or double walled vacuum insulated bowl integrally incorporated into a base.

In the given invention of the vacuum insulated canister and bowl the at least one user willing to use the vacuum insulated canister and bowl is enabled to fill the vacuum insulated canister with liquid and/or ice and couple the vacuum insulated canister to the vacuum insulated bowl using the following means. Firstly the second lid is removed from the main body of the first unit and filled with ice and/or liquid at the desired temperature to be maintained. The second lid is then threaded back onto the main body to contain the contents within the first unit. The at least one user is then enabled to couple the first unit to the second unit directly or store or transport the first unit until the use of the first unit and its contents are required. To couple the first unit to the second unit the first lid of the first unit is removed and magnetized to the main body of the first unit. The threaded male end of the second lid of the first unit is then threaded into the threaded female receiving couple of the second unit. The second unit coupled to the first unit is quickly placed in the desired location with the opening of the second unit facing up, enabling the liquid contained within the first unit to flow into the insulated bowl of the second unit via the coupling of the first and second units and through the insulated conduit of the second unit. As the bowl is filled with liquid the conduit will be closed to gases preventing fluid to enter the first unit preventing the displacement of liquid in the first unit until the liquid in the bowl of the second unit has been removed enabling fluids to be exchanged. Thereby, enables the bowl to be filled automatically by the contents of the first unit while retaining the needed liquid and ice within the coupled unit in an insulated form to prevent premature heating of the ice and/or liquid of the first unit and second unit.

### BRIEF DESCRIPTION OF THE DRAWING

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the first perspective view of the given invention according to an embodiment of the invention.

FIG. 2 illustrates the second perspective view of the given invention according to an embodiment of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention relates to a vacuum insulated liquid canister with bowl attachment for pets and animals enabled to retain the provided liquid and ice at temperature for long periods of time and therefore provides an efficient, portable, source of cold water to animals when and wherever required. The vacuum insulated double walled construction is made up of stainless steel with a gripping surface.

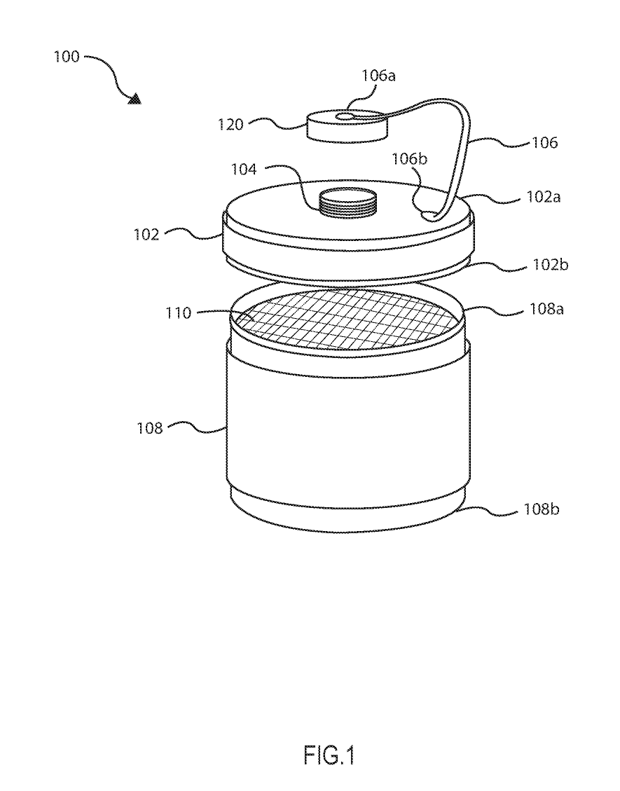

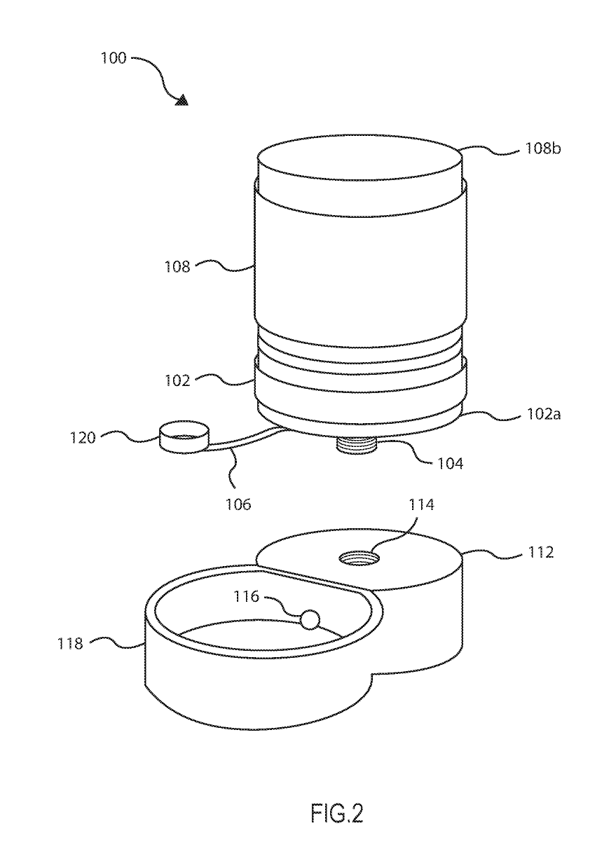

FIG. 1-2 illustrates the perspective view of the given invention according to an embodiment of the invention.

A vacuum insulated canister and bowl [100] for animals comprises:
The first unit [100] comprising a double walled insulated canister with a first lid [120] and a second lid [102]. The first lid [120] of the first unit enabling the canister to be closed completely and to be magnetized by the first end of the tether with magnet [106a] to the body of the canister [108b] when unfastened. The first lid [120] is further attached to the upper portion of the second lid [102a] by a tether [106] and the tether attachment [106b].
The second lid [102] of the first unit having a threaded male coupling [104] which is to be received by the receiving couple [114] of the second unit and a large threaded female coupling [102b] which allows the second lid to be coupled to the main body [108] of the first unit. The second lid [102] of the first unit and the main body of the first unit [108] are further encased either partially or completely on the outer surfaces with a grip material to provide a gripping surface to at least one user. The second unit [118] comprises a double walled vacuum insulated [112] threaded female receiving couple [114] with a conduit to a broad opening [116] or double walled vacuum insulated bowl integrally incorporated into a base [118].

The vacuum insulated canister first unit [100] herein, contains a double walled insulated housing provided with a first lid [120] with magnetized hardware unit [106a] to stow against the metal surface of the main body of the first unit [108b]. The first lid of the first unit [120] provided herein, is coupled to the top surface of the second lid of the first unit [102a] by the tether attachment [106b] connecting the tether [106] which is further attached to the first lid [120] by the attachment magnetized hardware unit [106a]. The tether [106] also acts as a carrying handle for the first unit [100]. Wherein the magnetized first lid [120] is further coupled to the threaded male coupling unit [104] to form a handle like structure of the tether [106] which provides the at least one user ease in carrying the vacuum insulated canister or first unit [100] to whichever place desired for its use. Further the second lid of the first unit [102] provided onto the upper portion of the first unit [108] enable the at least one user to add liquid and/or ice [110] inside the vacuum insulated canister [100]. The cooling element herein is ice which cools the temperature of the liquid dispensed through the second unit [118]. The second unit [118], enabled with a small threaded female receiving couple [114] is coupled to the coupling member [104] present on the second lid of the first unit [102] of the vacuum insulated canister [100] and wherein the second unit [118], having an insulated conduit in the base [116], is further coupled to a receiving tray to receive the liquid from the first unit [100] through the insulated conduit of the vacuum insulated double walled base [112]. The small size of the insulated conduit opening [116] provided in the second unit [118] enables only a specific quantity of the liquid to be dispensed from the vacuum insulated liquid dispenser [100] into the vacuum insulated bowl of the second unit [118] and only at the time when the opening of the bowl is emptied.

In the preferred embodiment the at least one user uses the vacuum insulated canister and bowl [100] by pouring water and/or ice [110] into the main body of the first unit [108]. Once the main body of the first unit [108] has been filled the threaded female portion the second lid [102b] is coupled to the threaded top section of the main body [108a] to contain the entire arrangement. The first unit is further enabled to be rotated 180 degrees, wherein the threaded male coupling member [ψ] couples to the threaded female couple [114] present on the second unit [118]. The second unit [118] further comprises a double walled vacuum insulated base [112] and an insulated conduit [116] ending in a bowl opening. The small insulated conduit [116] enables only a specific quantity of the liquid to be dispensed from the first unit and only at the time when required, as the small insulated conduit opening [116] when covered with liquid does not allow air into the first unit [100] for additional water to flow freely through the insulated conduit. The second unit [118] herein is also insulated therefore the liquid dispensed out of the first unit [100] into the second unit [118] remains at its desired temperature for longer period of time.

What is claimed is:

1. A vacuum insulated canister and bowl for animals comprises:
a) a first unit having a first lid, a second lid and a main body, wherein the second lid of the main body is removable enabling a liquid and/or ice into the first unit;
b) a second unit, enabled with a small female threaded opening is coupled to the coupling member present on the first unit of the vacuum insulated canister and bowl wherein the second unit, having an opening in the base, is further coupled to a receiving bowl to receive the liquid from the first unit through the opening and insulated conduit of the second unit.

2. The vacuum insulated canister and bowl for animals in claim 1; wherein the receiving bowl is also insulated in order to maintain the desired temperature of the liquid.

3. The vacuum insulated canister and bowl for animals in claim 1; wherein the vacuum insulated wall is of double walled vacuum housing and therefore provides better insulation for the hot or the cold liquid provided vacuum insulated canister and bowl for animals.

4. The vacuum insulated canister and bowl for animals in claim 1; wherein the coupling member is provided with a magnetized cover member in order to be stowed against the outside wall of the vacuum insulated water canister.

5. The vacuum insulated canister and bowl for animals in claim 1; wherein the first unit of the vacuum insulated canister and bowl is provided with a tether connecting the first lid and the second lid for use as a grip member that is enabled to be used as the handle for the vacuum insulated canister to provide easy handling of the vacuum insulated canister for carrying the vacuum insulated canister to different places of its use.
